(19) United States
(12) Patent Application Publication
(10) Pub. No.: US 2004/0035776 A1
(43) Pub. Date: Feb. 26, 2004

(54) Quick disconnect inline filter

(76) Inventor: Richard Coleman, Menominee, MI (US)

Correspondence Address: GODFREY & KAHN S.C., 780 NORTH WATER STREET, MILWAUKEE, WI, 53202, US

(21) Appl. No.: 10/226,631

(22) Filed: Aug. 23, 2002

(51) Int. Cl. B01D 35/30

(52) U.S. Cl. 210/232

(57) ABSTRACT

A quick disconnect housing apparatus includes a housing that has a quick disconnecting latch means and an end cap. The quick disconnecting latch in one embodiment is a hingedly attached, pivotably rotatable lever. In one engagement orientation of the lever, the end cap and the housing are mechanically sealed. In another disengagement orientation of the lever, the end cap and the housing are disengaged whereby easy inspection and installation of an interior element is possible. A method of inspecting and changing the interior element is also disclosed.

### BACKGROUND OF THE INVENTION

This invention generally relates to a quick disconnect housing apparatus and a method of quick inspection and installation of a quick disconnect housing apparatus. Specifically, the invention relates to a quick disconnect inline filtering apparatus for dry sump oil systems and a method of inspecting and installing quick disconnect filtering apparatus.

In the arena of auto racing, time is of essence. During racing, there are several thousand parts under extreme stress. These parts require quick inspection and maintenance with only short duration of time to spare, as in the case of pit stops. Among other things, such as gasoline and tire pressure that are sometimes inspected during a short pit stop, an auto mechanic may need to inspect or change the inline filtering apparatus for dry sump oil systems.

Inline oil filter systems are used in connection with dry sump oil systems that are typically used in racing vehicles. The dry sump oil system requires the use of an inline oil filter between the engine and the oil tank, which is typically located in the rear end of the vehicle. Upon inspection, if the filter contained inside the filtering apparatus has undesirable level of contaminants, the filter must be replaced immediately, such that the efficiency and performance of the car is not affected. Dry sump oil systems are typically used in racing vehicles because engines with dry sump oil systems have been found to have a significant horsepower advantage and other advantages over wet sump oil systems.

Inspection and replacement of inline filters in conventional systems require the unclamping and unthreading of the inline filter. It has been found desirable in the industry to be able to quickly check and replace the filter in the inline oil filter system. However, presently in the industry, the filtering apparatus consists of a cylindrical canister shell containing a filter that can only be removed by unscrewing the end cap using a mechanical tool, e.g., Canton/Mecca Filters C/M Remote Inline Oil Filter with 8 micron element, 25-103 (3/4NPT). In certain situations, especially where time is of essence, unscrewing to inspect and install an inline filter in the dry sump oil system followed by again screwing back the end cap is very inefficient.

FIG. 1 is an illustration of a prior art hose connector used to connect two different hoses for use in spraying and irrigation applications for agricultural fields. The hose connector is manufactured by ARAG Spraying and Irrigation, s.r.l Via Palladio 5/A 42100 Rubiera (RE) Italy. This device includes a latch 20, which is attached to the first hollow pipe 22. The second hollow pipe connector 24 has an external diameter 26 slightly less than the internal diameter 28 of the first pipe 22 such that the second pipe 24 is insertable in the first pipe 22. When the second pipe 24 is inserted into the first pipe 22, the latch 20 is pivoted so that the first pipe 22 and the second pipe 24 are mechanically sealed.

There are many types of existing filtering systems, which use various disconnecting and sealing means. Examples of such types of filtering systems are disclosed in U.S. Pat. No. 3,868,325 to Otto; U.S. Pat. No. 3,993,561 to Swearingen; U.S. Pat. No. 4,151,823 to Gross et al; and U.S. Pat. No. 4,557,834 to Mason.

Accordingly, the need exists for an improved filtering apparatus that can be quickly disconnected such that the filter inside the canister can be inspected or exchanged within a short duration of time and without the aid of any specialized tools. Of course, the present invention may be used in a multitude of systems where similar quick disconnecting, inspecting, and replacing capabilities are desired. Thus, the present invention should not be interpreted as being limited to application in connection with inline oil filters used in dry sump oil systems.

### SUMMARY OF THE INVENTION

The present invention is a quick disconnect housing apparatus that is easily installed in a fluid system. The quick disconnect housing apparatus is cost-effective and is adaptable for use in connection with various fluid systems.

In one embodiment of the present invention, the quick disconnect housing apparatus includes an inline oil filter apparatus for removing contaminants from a dry sump oil system. The apparatus generally includes an end cap, a housing, an inner assembly removably placed within the housing and covered by the end cap and a quick disconnecting latch means for disconnecting the end cap from the housing. Other embodiments of the invention include, without limitation, placing other devices within the housing such as dispensing canisters.

Another embodiment of the present invention includes a method for inspecting an inline oil filter in a dry sump oil system. The method includes the steps of: pivoting a quick disconnecting latch, sliding an end cap from a housing, removing the filter contained inside the inline oil filter, inspecting the filter for contaminants, replacing the filter or providing a new inner filter, placing the end cap into the housing, pivoting the quick disconnecting latch such that the end cap is secured in the housing.

In sum, the present invention represents a significant improvement over the prior art in many ways, including allowing quick inspection and change of inner assembly, economical design, and ease of use. These and other objects and advantages of the present invention will become apparent from the detailed description accompanying the drawings.

### DESCRIPTION OF THE DRAWINGS

FIG. 1 is an exploded view of a prior art hose connector;

FIG. 2 is an exploded view of one embodiment of a quick disconnect inline oil filter in accordance with the invention;

FIG. 3 is a cap end perspective view of one embodiment of a quick disconnect filtering in accordance with the invention;

FIG. 4 is a housing end perspective view of the quick disconnect filtering apparatus of FIG. 3;

FIG. 5 is a housing end perspective view of the quick disconnect filtering apparatus of FIG. 3 with the quick disconnect latch in an open position;

FIG. 6 is a housing end perspective view of the end cap of FIG. 2;

FIG. 7 is a end cap end perspective view of the quick disconnect filtering apparatus of FIG. 3 with the end cap removed and the quick disconnecting latch shown in open position;

FIG. 8 is an oil line end perspective view of the end cap of FIG. 2;

FIG. 9 is a plan view of the end cap end of the quick disconnect filtering apparatus of FIG. 7, shown with end cap removed and latches in an open position;

FIG. 10 is a partial section perspective view of the quick disconnect filtering apparatus of FIG. 3; and

FIG. 11 is a cross-sectional view of the quick disconnect filtering apparatus of FIG. 10.

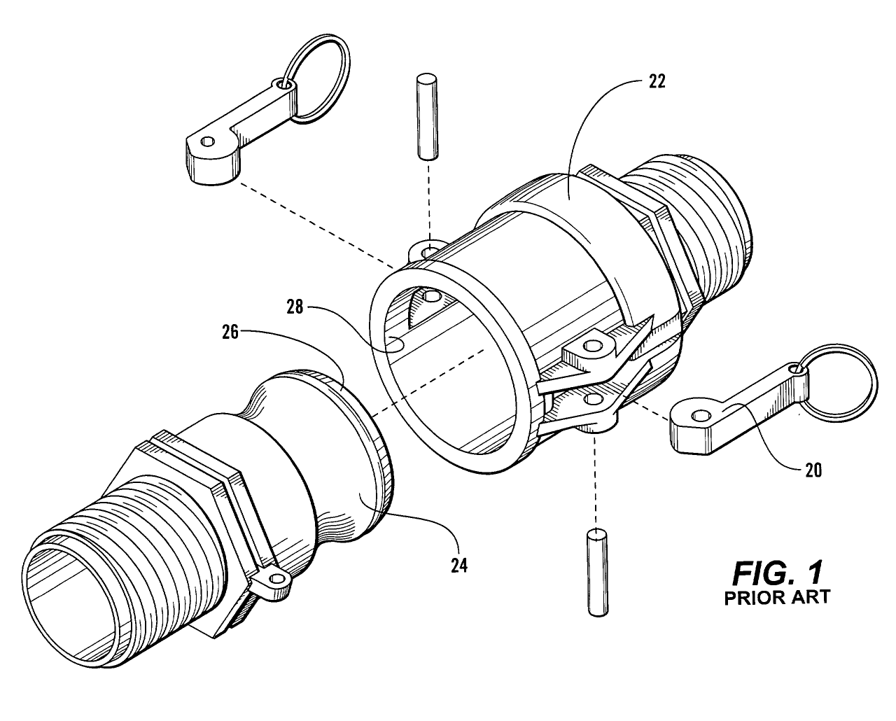

### DETAILED DESCRIPTION OF THE PREFERRED EMBODIMENTS

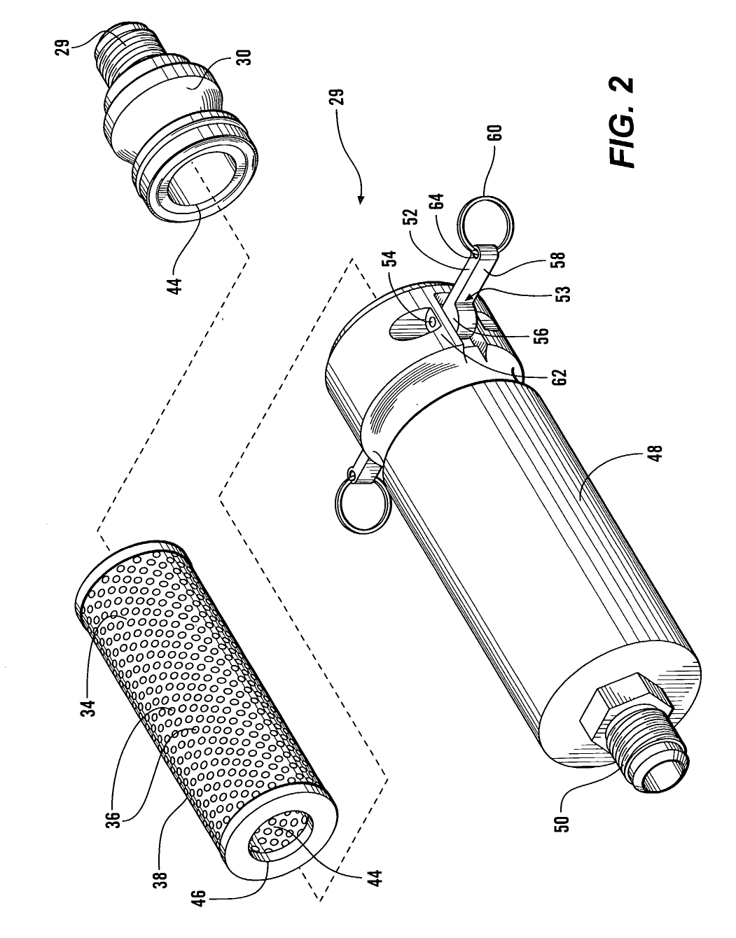

FIG. 2 shows one embodiment of the quick disconnect apparatus 29 wherein the end cap 30 contains an inlet 32 for receiving oil from upstream of the filter. The end cap 30 is attached to the upstream source through the inlet 32 by any conventional means, such as threading as shown in FIG. 2. The end cap 30 may be manufactured by conventional materials that are used in manufacturing filter canisters and that are known by one skilled in the art, such as stainless steel or aluminum.

As seen in FIGS. 6 and 8, the end cap 30 has a connector part 66, which is generally cylindrical in shape. The connector part 66, has at least one reduced diameter groove 68 along the external circumference of the exterior surface of the end cap 70. The connector part 66 may include O-rings 67 and 69 to ensure that the end cap 30 is sealed within the housing 48, when the end cap 30 is inserted in the housing 48.

The quick disconnect apparatus 29 uses any conventional inner assembly, such as a filter 34 for the purpose of removing desired contaminants. In one embodiment of the present invention, the filter 34 comprises a concentrically aligned double cylindered chamber that contains a mesh (not shown) in the area between its internal cylinder 40 and its external cylinder 38. The mesh comprises the filtering surface. Both the external cylinder 38 and the internal cylinder 40 have a plurality of perforations 36, such that the perforations 36 on the external cylinder 38 are not aligned along the perforations 36 of the internal cylinder 40. The lack of alignment of the perforations 36 in both the external cylinder 38 and the internal cylinder 40 forces the incoming fluid inside the internal cylinder 40 to flow from the internal cylinder 40 to the outer cylinder 38 through the filtering surface of the mesh, where the process of filtration occurs. Further, the internal diameter 44 of the end cap 30 is similar to the internal diameter 46 of the filter 34. Similar internal diameters, 44, 46 ensures that any fluid entering the inlet 32 also enters the inner cylinder 40, such that maximum filtration occurs when the fluid is pushed towards the outer cylinder 38.

Other conventional or novel inner assemblies may be used in the quick disconnect housing apparatus, for example, a dispensing canister that contains desired fertilizers or pesticides or other chemicals that need to be dispensed. When chemicals contained in the dispensing canister are depleted, the quick disconnect housing apparatus can be quickly disconnected and the chemical can either be refilled or the entire inner assembly may be replaced. In one embodiment, the dispensing canister may include concentrated chemicals inside the body of the dispensing canister, which is, in turn placed in the housing 48.

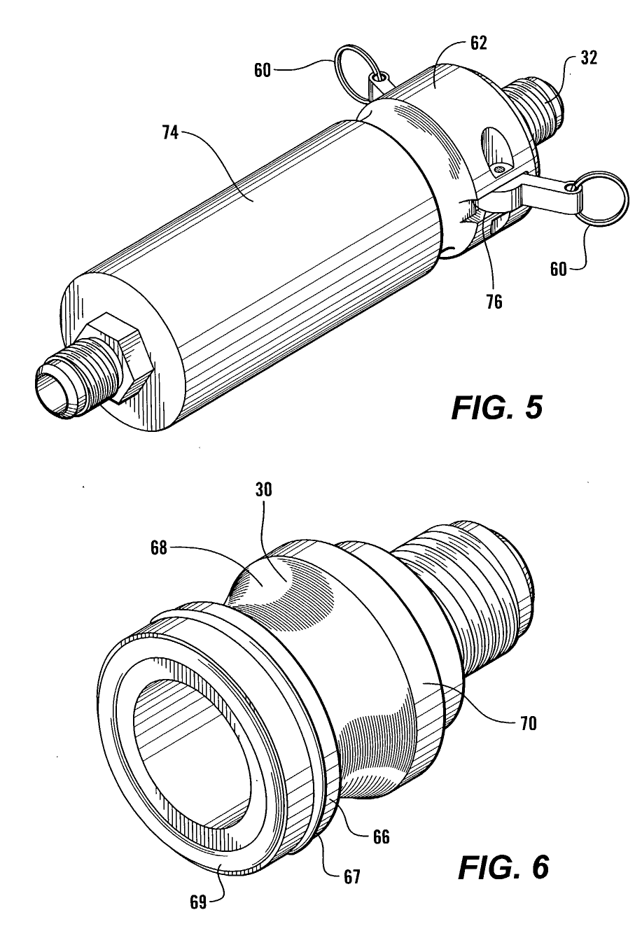

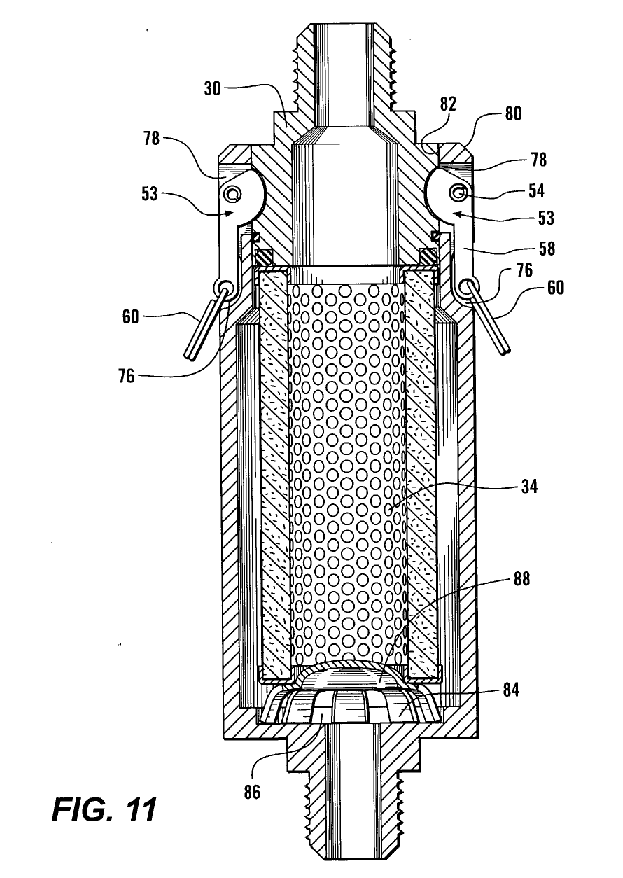

In one embodiment of the present invention, the inner assembly is a filter 34 that resides inside the housing 48. In this embodiment, the housing 48 includes an outlet 50 capable of conveying the oil downstream. The housing 48 may be made of the same materials as the end cap 30. The housing is generally cylindrical in shape and may be viewed as including mainly two parts. The first part is the main body 74 as seen in FIG. 5 and the second part is the connector head 62. The connector head 62 is also substantially cylindrical in shape and has at least one slot 76. As seen in FIG. 11, the connector head further includes at least one orifice 78 traveling through the exterior surface of the housing 80 into the interior surface of the housing 82. In one embodiment of the present invention, there are two slots 76 and two corresponding orifices 78.

In one embodiment of the present invention, the housing 48 also includes a cushion 84. This cushion 84 may be manufactured by any known composition known in the prior art by one skilled in the art, which is chemically resilient such that no chemical reaction occurs when fluids pass through the filtering apparatus 29. The cushion 84 structurally serves the purpose of keeping the filter 34 in one position, so that the filter 34 does not rattle against the interior wall of the housing or the connector part 66 of the end cap 30. The cushion 84 is slightly compressible. When the quick disconnecting means 52 mechanically pushes the end cap 30 and the housing 48 in a locked position, the slightly compressible cushion 84 allows pressure caused by such mechanical sealing to dissipate such that the filter 34 is not damaged.

In one embodiment of the present invention, the cushion 84 is substantially arcuate in shape as seen in FIG. 11 and is positioned at the bottom of the housing 48. The cushion 84 may be substantially shaped like a hollow dome with a solid circular center 88 and a plurality of cavities 86. In one embodiment of the present invention, the plurality of cavities 86 are arch-like. In another embodiment of the present invention, the solid circular center 88 has a diameter greater than or equal to the diameter of the internal cylinder 40 of the filter 34. The diameter of center 88, which is greater than or equal to the diameter of the internal cylinder ensures that the incoming fluid does not simply pass through the outlet 50 of the housing. The diameter of the solid circular center 88, instead forces the fluid to pass through the perforations 36 of the internal cylinder 40, followed by the external cylinder 38, followed by the plurality of cavities 86 and finally to the outlet 50 of the housing.

The housing 48 further includes a quick disconnecting means 52. This quick disconnecting means 52 is hingedly attached to the housing slots 76, using conventional pivotable attachers. In one embodiment, the attachers are a hinge pins 54. The hingedly attached quick disconnecting means 52 is a pivotably rotatable lever 53, which includes a lever head 56, a lever handle 58 and may include a means for grasping the lever handle 58 such as ring 60. The lever 53 is held in position inside slot 76 by inserting the hinging pin 54 first through the body of the connector 62 then through the lever head 56 and finally through the body of the connector 62, again.

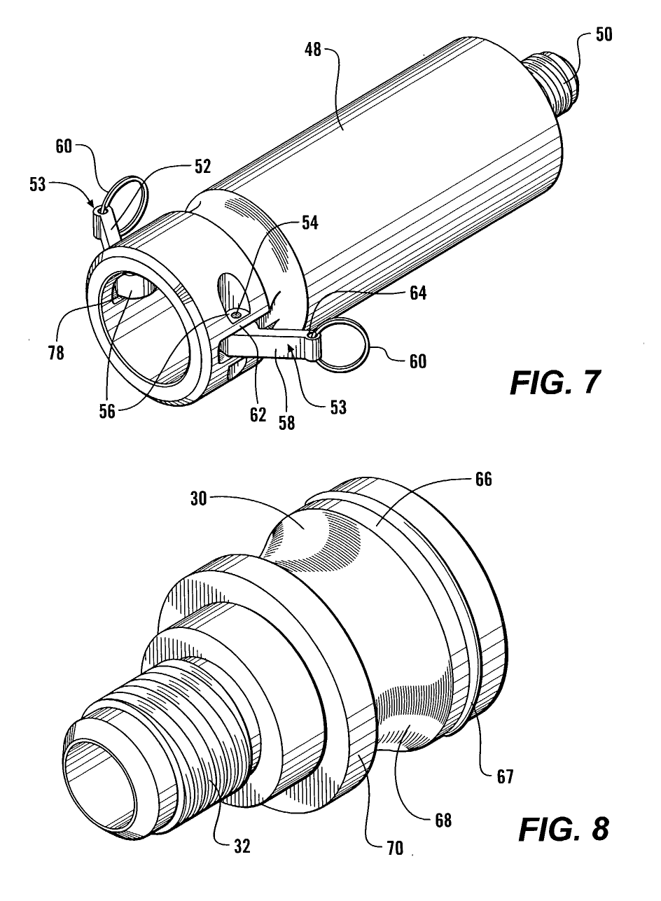

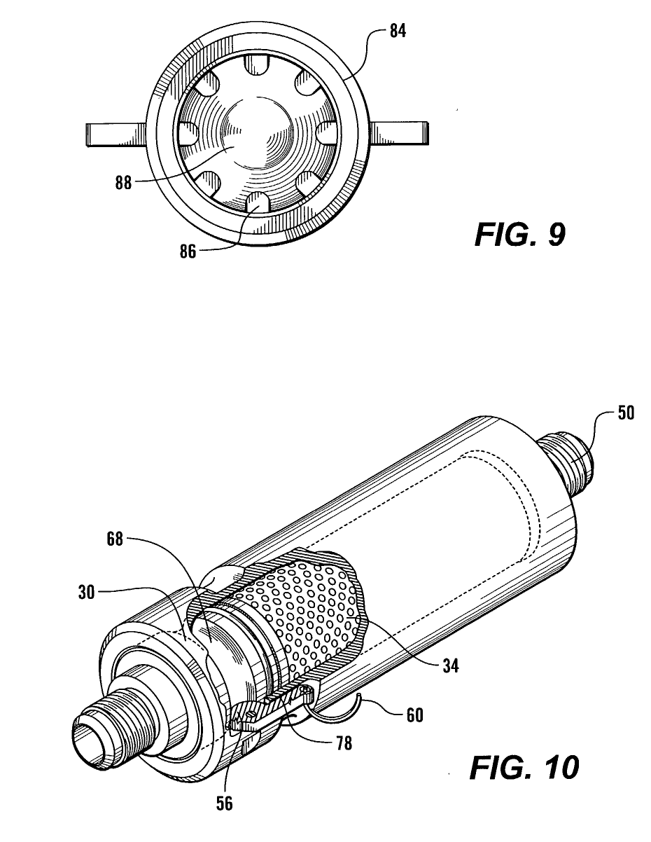

As seen in FIGS. 7 and 11, in one embodiment of the invention, the quick disconnecting means 52 is operated by rotating the lever handle 58, using the pivoting point of the hinge attacher 54. The lever handle 58 is rotated such that the lever handle 58 pushes the lever head 56 inside the orifice 78, thereby protruding the lever head 56 inside the interior surface of the housing 82. As seen in FIG. 10, the lever head enters the orifice 78 and settles on to the groove 68 of the exterior surface of the end cap. This is the position of engagement. The second position of disengagement occurs when the lever handle 58 is rotated such that the lever head 56 inside the orifice 78 is not protruding, but is instead aligned to the interior surface of the housing 82.

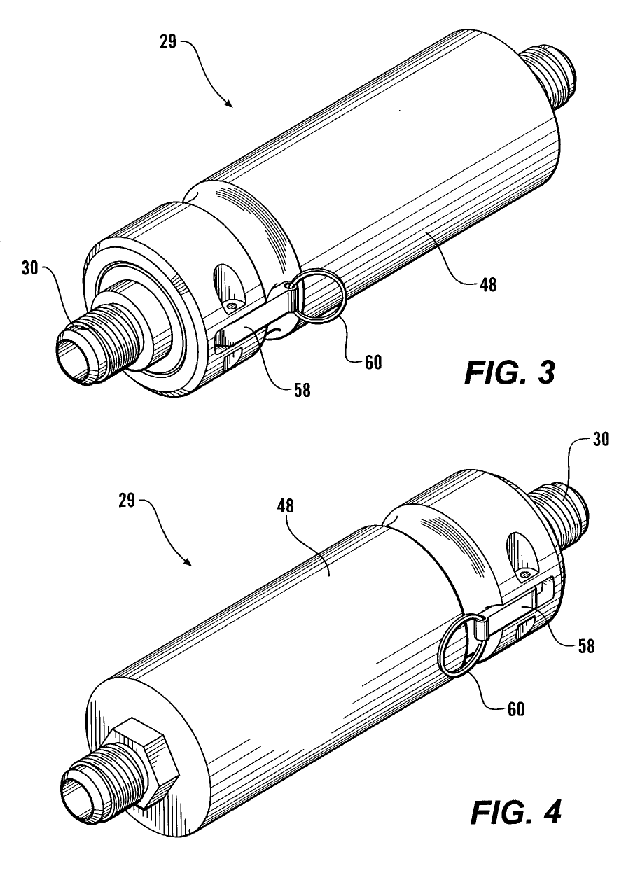

In a normal operating position, the end cap 30 and the housing 48 containing the filter 34 of the filtering apparatus 29 are mechanically locked using the quick disconnecting device. In order for the apparatus 29 to operate as a quick disconnect inline filter, in one embodiment of the present invention, the lever handle 58 is rotated to the disengagement position. The disengagement position allows the lever head 56 to align with the interior surface of the housing 82, thereby allowing for the enclosed filter 34 to be released. The filter 34 is then inspected for desired contaminants, and after inspection, the filter 34 is replaced inside the housing 48, optionally with a new filter 34, depending on the level of contamination. Once the filter is positioned inside the housing above the compressible perforated cushion 84, the end cap 30 is aligned with the housing 48 and the lever handle 58 is positioned in the engagement position, thereby quickly locking the filtering apparatus 29, as seen in FIGS. 3 and 4.

The quick disconnect inline oil filtering apparatus and a method of installing and inspecting an inline oil filtering apparatus of the present invention may have other applications aside from use in a dry sump oil system. Additionally, the direction of fluid flow has been described herein in the preferred orientation but it should be apparent to one of skill in the art that the flow direction could be reversed. Thus, although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims.

I claim:

1. A quick disconnect housing apparatus, comprising:
a housing, the housing having an interior, a connector end, and a housing outlet for communicating fluid to or from the interior of the housing;
an end cap dimensioned to removeably fit within the connector end of the housing, the end cap having an end cap outlet for communicating fluid to or from the interior of the housing;
an inner assembly removeably positioned within the interior of the housing and held within the interior of the housing by the end cap when the end cap is removeably fit within the connector end of the housing; and
a quick disconnecting latch positioned on the connector end of the housing, the quick disconnecting latch moveable between an engagement position and a disengagement position, the end cap removeable from the connector end of the housing when the quick disconnect latch is in the disengagement position, and the end cap secured within the connector end of the housing when the quick disconnect latch is in the engagement position.

2. The quick disconnect housing apparatus of claim 1, wherein the inner assembly is a filter.

3. The quick disconnect housing apparatus of claim 1, wherein the inner assembly is a dispensing canister.

4. The quick disconnect housing apparatus of claim 2, wherein the end cap outlet is a threaded end dimensioned for connection to an oil line.

5. The quick disconnect housing apparatus of claim 2, wherein the housing outlet is a threaded end dimensioned for connection to an oil line.

6. The quick disconnect housing apparatus of claim 1, wherein the quick disconnecting latch is hingedly attached to the housing such that it is moveable between the engagement position and the disengagement position.

7. The quick disconnect housing apparatus of claim 6, wherein the quick disconnecting latch further comprises a lever handle and a lever head, the lever head positioned on the housing such that it protrudes into the interior of the housing when the quick disconnecting latch is in the engagement position and does not protrude into the housing when the quick disconnecting latch is in the disengagement position.

8. The quick disconnect housing apparatus of claim 7, wherein the end cap includes a reduced dimension groove, the lever head of the quick disconnecting latch positioned on the housing to engage the reduced dimension groove when the end cap is fit within the connector end of the housing and the quick disconnecting latch is in the engagement position so as to retain the end cap within the connector end of the housing.

9. A method of inspecting an inner assembly positioned within an interior of a housing, the method comprising the steps of:
pivoting a quick disconnecting latch positioned on a connector end of the housing such that the quick disconnecting latch moves from an engaged position to a disengaged position;
removing an end cap from the connector end of the housing;
removing the inner assembly from its position within the interior of the housing;
inspecting the inner assembly;
replacing an inner assembly into the interior of the housing;
replacing the end cap into the connector end of the housing; and
pivoting the quick disconnecting latch positioned on the connector end of the housing such that the quick disconnecting latch moves from a disengaged position to an engaged position.

10. The method of claim 9 wherein the inner assembly is an oil filter.

11. The method of claim 9 wherein the step of replacing an inner assembly into the interior of the housing comprises the step of replacing the same inner assembly that was removed.

12. The method of claim 9 wherein the step of replacing an inner assembly into the interior of the housing comprises the step of placing a new inner assembly into the interior of the housing.

13. The method of claim 9 wherein the step of pivoting the quick disconnecting latch positioned on a connector end of the housing such that the quick disconnecting latch moves from an engaged position to a disengaged position further comprises moving a lever head from a position of protruding into the interior of the housing such that it is engaged in a groove in the end cap to a position of not protruding into the interior of the housing.

14. The method of claim 13 wherein the step of pivoting the quick disconnecting latch positioned on the connector end of the housing such that the quick disconnecting latch moves from a disengaged position to an engaged position comprises moving a lever head from a position of not protruding into the interior of the housing to a position of protruding into the interior of the housing such that it is engaged in the groove in the end cap.

15. A quick disconnect inline oil filter assembly comprising:
a housing, the housing having an interior, a connector end, and a housing outlet for communicating fluid to or from the interior of the housing to or from an oil line;
an end cap dimensioned to removeably fit within the connector end of the housing, the end cap having an end cap outlet for communicating fluid to or from the interior of the housing to or from an oil line, the end cap further having a reduced dimension groove;
an oil filter removeably positioned within the interior of the housing and held within the interior of the housing by the end cap when the end cap is removeably fit within the connector end of the housing;
a quick disconnecting latch pivotably positioned on the connector end of the housing, the quick disconnecting latch having a lever handle and a head, the head positioned on the housing such that it protrudes into the interior of the housing to engage the reduced diameter groove of the end cap when the quick disconnecting latch is in an engagement position and does not protrude into the interior of the housing and does not engage the reduced diameter groove when the quick disconnecting latch is in a disengagement position; and
wherein the quick disconnecting latch is moveable between the engagement position and the disengagement position, the end cap removeable from the connector end of the housing when the quick disconnect latch is in the disengagement position, and the end cap secured within the connector end of the housing when the quick disconnect latch is in the engagement position.
